(19) United States
(12) Patent Application Publication
(10) Pub. No.: US 2024/0141557 A1
(43) Pub. Date: May 2, 2024

(54) Methods and Apparatus for High-Resolution Textile Fabrication with Multimaterial Intelligent Fibers

(71) Applicant: Neox Public Benefit LLC, New York, NY (US)

(72) Inventor: Neri OXMAN, New York, NY (US)

(21) Appl. No.: 18/548,505

(22) PCT Filed: Mar. 2, 2022
(86) PCT No.: PCT/US2022/018514

§ 371 Date: Aug. 31, 2023

Related U.S. Application Data
(60) Provisional application No. 63/156,080, filed on Mar. 3, 2021.

(51) Int. Cl. D01F 8/18; B33Y 99/00; D01D 5/00; D03D 13/00; D03D 15/292; D03D 25/00; D04H 1/728

(52) U.S. Cl. CPC D01F 8/18; B33Y 99/00; D01D 5/0007; D03D 13/002; D03D 15/292; D03D 25/005; D04H 1/728

(57) ABSTRACT

Systems and methods for forming a product formed from intelligent fibers that includes at least one of a mono-material fiber; a coaxial fiber; and a continuous fiber. The fibers react to an environmental stimulus such as a mechanical, thermal, chemical, biological, or magnetic stimulus to provide a feedback to a user. The feedback may be change in color, shape, or material property. The fibers may comprise chromophores, force detection wires, and/or fiber optics. The invention can be used to prepare products such as a shoe, garment, textile, building material, or engineered hybrid plant product.

This application claims the priority benefit of U.S. provisional patent application No. 61/156,080, filed Mar. 3, 2021, the contents of which is incorporated herein by reference in its entirety.

### FIELD OF THE INVENTION

The present invention relates generally to products and methods of making products from smart or intelligent fibers including one or more functional materials that may provide various functionalities such as sensing, actuation, and/or communication behaviors that vary predictably across space and time to sense and react to environmental stimuli, such as mechanical, thermal, chemical, biological and/or magnetic stimuli, for example.

### BACKGROUND OF THE INVENTION

Three types of media power our world, namely, energy, matter, and information. These media transform into one another as they flow along bidirectional pathways between the cloud, the environment, and us. As apparel wearers (e.g., athletes) move through their environment, wearable technologies may enable them to communicate and collect social, physiological and environmental data. In turn, data can inform the design of apparel, such as shoes, with material properties functionally optimized not only to augment athletic performance but also (and importantly) to minimize destructive impacts on the natural environment.

Various smart textiles are available to enhance textile products using smart fibers to form smart textiles which may be classified as passive smart, active smart and intelligent textiles. Passive smart textiles only have sensors that provide detection functions to sense environmental conditions or stimulus. Active smart textiles not only have sensors but also have actuators that may be actuated in response to stimulus sensed by the sensors where a controller may be included to control the actuators in response the stimulus sensed by the sensors. Intelligent textiles go a step further than active smart textiles by more intelligently reacting to environmental conditions or stimulus, where instead of a simple controller, a processor may be included that may be programmed to monitor conditions sensed by sensors, adapt and perform desired functions in response to inputs including stimulus sensed by the sensors and/or other inputs. Thus, instead of merely reacting to stimulus sensed by the sensors, intelligent textiles respond and adapt to the sensed stimulus as well as to other inputs such as provided by the wearer and/or another user or entity monitoring the wearer, for example, a health professional, an athletic coach, a leader of a group such as a military unit and the like.

While smart textiles provide many benefits as compared to ‘dumb’ textiles, there is a need for improved smart textiles and smart fibers, not only to increase comfort and performance of a wearer but also to provide better control and adaptions to various stimuli. Further, there is a need for the ability to create intelligent textiles wherein the constituent fibers themselves may be biologically augmented, engineered or synthetically modified to encode functionality directly into bio-based materials.

### SUMMARY OF THE INVENTION

The system, device, method, arrangement, user interface, computer program, processes, etc. of the present invention address problems in prior art systems.

The system and method of the present invention relate to an intelligent fiber for forming a product that may be worn, namely any garment, clothing and/or apparel, such as a shoe, shirt, glove, hat, pants and the like. In one embodiment, the product may be formed from intelligent fibers comprising at least one of mono-material fiber; a coaxial fiber; and a continuous fiber. The mono-material fiber includes at least two adjacent fibers, a first fiber of the at least two fibers being formed from a first material and being adjacent to a second fiber of the at least two fibers, and the second fiber being formed from a second material being different from the first material. The coaxial fiber includes at least two coaxial fibers, a first fiber of the at least two coaxial fibers being formed from the first material and surrounding a second coaxial fiber of the at least two coaxial fibers formed from the second material. The continuous fiber includes at least two serial fibers, a first fiber of the at least two serial fibers being formed from the first material and having a first end connected to a second end of a second serial fiber of the at least two serial fibers formed from the second material.

In an embodiment, mono-material fibers may be triaxially interwoven to form the product. Alternately or in addition, coaxial fibers may be three-dimensional (3D) printed to form the product, and/or continuous fibers may be electro-spun or 3D printed to form the product.

Thus, it is an object of the invention to provide an intelligent fiber or garment having not only pleasing aesthetics, but also the ability to sense the environment and intelligently react to the sensed environment. Such a garment provides not only comfort and enhanced performance allowing the user to better perform and withstand harsh environments, but also may facilitate monitoring and supporting the wearer's performance and well-being.

### BRIEF DESCRIPTION OF THE DRAWINGS

The present invention is explained in further detail in the following exemplary embodiments with reference to the figures, where the features of the various exemplary embodiments are combinable. Note that the drawings are provided as an exemplary understanding of the invention and to schematically illustrate particular embodiments of the invention. The skilled artisan will readily recognize other similar examples that are equally within the scope of the invention. The drawings are not intended to limit the scope of the invention as defined in the appended claims.

FIG. 1A shows a fiber structure formed of three mono-material fibers, each mono-material fiber having a different functionality from the material of the other two fibers. FIG. 1B shows a fiber structure formed of three distinct materials in concentric shells. FIG. 1C shows a fiber structure formed of three distinct materials oriented in segments.

FIGS. 2A and 2B show different embodiments of three mono-material fibers triaxially interwoven in various patterns. FIG. 2C shows triaxially interwoven fibers forming an unfolded shoe.

FIGS. 3A and 3B show different embodiments of a single coaxial fiber extruded with multiple materials in concentric shells which has been triaxially interwoven. FIG. 3C shows 3D printed coaxial fibers forming an unfolded shoe.

FIGS. 4A and 4B show embodiments of a single ultrafine continuous fiber formed by electrospinning with varying material composition along its length and which has been interwoven in various patterns. FIG. 4C shows the electrospun fibers forming an unfolded shoe.

FIG. 5 shows an embodiment of a mesh of fibers in the form of a shoe printed along Voronoi grid lines.

FIGS. 6A and 6B show embodiments of porcupine fibers or whiskers that extend outwards from a shoe.

FIG. 7A shows an embodiment of a polymer melt comprising natural fibers which had been fed into a spinneret mounted on an actuated arm of a 3D printer or robotic arm which functions as a shoe last. FIG. 7B shows an embodiment of a second polymer melt comprising additives fed into a second spinneret mounted on the same or different actuated arm. FIG. 7C shows a geometry of fibers that has been computationally designed to provide particular material properties to a shoe. FIG. 7D shows an embodiment of a folded shoe formed from electrospun fibers.

FIGS. 8A-8B show a layer of inflatable cells in the form of a shoe having Voronoi tessellations. FIG. 8C shows an embodiment of a mandrel for use in weaving an intelligent fiber to optimize functionality of a shoe. FIG. 8D illustrates surface-based Voronoi tessellation applied to a 3D woven structure having inflatable bubbles to provide features such as spatially differentiated cushioning. FIG. 8E shows an unfolded shoe formed on a collector in the shape of a 2D metal plate.

FIG. 9A shows shape deformation of a breathable electrospun material in response to moisture conditions to thereby generate a wrinkling effect that increases surface area of the material. FIG. 9B shows a mesh of such electrospun fibers forming an unfolded shoe.

FIG. 10A shows illustrative stages of a shoe starting from a base or liner, and volumetric material distribution and droplet deposition using different material deposited by 3D printing. FIG. 10B illustrates an embodiment of an apparatus for multimaterial voxel-based 3D printing.

FIG. 11 shows a block diagram of a system for printing of a textile product such as a shoe from the intelligent fibers described herein.

FIG. 12 shows a method of making a product from intelligent fibers.

FIG. 13 shows an embodiment of a hybrid plant template in the form of a shoe sole for growing a hybrid plant product.

FIGS. 14A-14D show embodiments of hybrid plant templates for containing and harvesting plant seeds within plant-based soles and apparel.

FIGS. 15A-15D illustrate a sequence of growth of plants in an embodiment of a hybrid plant product template.

FIG. 16 shows an embodiment of a shoe having soil sensitive shoe mechanics for spatial and temporal response.

### DETAILED DESCRIPTION OF THE PRESENT SYSTEM

The present invention relates generally to products and methods of making products from intelligent fibers which may comprise one or more functional materials that may provide various functionalities such as sensing, actuation, and/or communication behaviors that vary predictably across space and time, thereby resulting in smart or intelligent textile products that may sense and react to environmental stimuli such as mechanical, thermal, chemical, biological and/or magnetic stimuli as well as provide feedback to the wearer and/or others, for example.

The following description is set forth, for illustrative purposes rather than limitation. It will be apparent to those of ordinary skill in the art that other embodiments which depart from these details would still be understood to be within the scope of the appended claims. Moreover, for purposes of clarity, detailed descriptions of well-known devices, circuits, tools, techniques, and methods are omitted so as not to obscure the description of the present invention. The term and/or formatives thereof should be understood to mean that only one or more the recited elements may need to be suitably present in an embodiment in accordance with the claimed recitation.

For better clarity and simplicity, the present invention will be described in the context of a shoe. However, it should be understood that the present invention is applicable to any type of product, not limited to shoes, garment, structure, tangible good, textile, building material, engineered hybrid plant products, and/or other products made from the intelligent fibers and/or products containing such fibers, including but not limited to, e.g., chairs, mattresses, carpets, wall paper, storage containers, frames, shelving, mobile devices. The following exemplary categories of types of uses for the resulting product illustrate how the intelligent fibers of the present invention can be manufactured to contain particular functionalities.

Information/Data Wearer

A data wearer may be viewed as an apparel wearer who is collecting and providing data passively, such as collected, stored and distributed by the intelligent apparel worn by the wearer. The data wearer unites the body with the cloud through the medium of information. Data collected during wear may be used to unite the body with the cloud through the medium of information. The human body can be a powerful conduit for transparent (or unobtrusive) collection of information and this data can be made transparent (or accessible) for a vast array of purposes. For example, a shoe may be composed of material embedded with gold nanoparticles or fiber optics that sense and record a literal environmental footprint. The shoe may be configured to read such environmental data as soil composition, air quality, or the type of terrain underfoot, which can be used both for societal contributions (e.g., map data sets, biodiversity surveys) and to inform immediate adaptation of shoe biomaterial properties to help the wearer interact more safely and less destructively with nature (e.g., increase traction on ice, modulate breathability). Extending to the social domain, the shoe may also be configured to function as a wearable computer, simultaneously operating as a camera, smartphone, and a Global Positioning System (GPS) receiver, for example. Further, in the health domain, the shoe may be configured to sense chemical markers in sweat, composition of the foot microbiome, blood oxygen saturation, heart rate, and/or mechanical patterns of biomechanics.

Data may be collected from apparel worn by a user, such as shoes, for example. Such a shoe for data functionality may include several types of fibers such as fiber optics for light and/or force detection, wires, pressure sensitive pads, force sensing “whiskers”, chromatophore-inspired pigments, conductive materials, and/or gold nanoparticles to provide for data collection as well as output of signals that cause changes in the material of the shoe to provide various functions and/or enhance performance. For example, fiber and other material of the shoe may be configured to provide various functions such as sensing, actuating, and/or light-emitting. Such data fibers with sensing and actuating features allow for changing color and shape of the shoe, such as to provide increased cushioning, where needed in response to sensing pressure points during walking or running, for example, by inflating air bubbles in the shoe or increasing elasticity of memory foam of the shoe.

Energy/Eco Wearer

An ecological (eco) wearer may be viewed as an apparel wearer who is passively helping the environment, not only by reducing waste (e.g., when shoes end up in a land fill) but also contributing to seed dispersion and plant growth. The ecological (eco) wearer unites the cloud with the environment through the medium of energy. A rich ecological data set informs sustainable design of the shoe using entirely plant-based materials, including uppers woven from natural fibers and hydrogel soles integrated with a seed dispersion system. The shoe may be programmed to perform specific functions over its lifetime. As wearer run through their environment, native seeds or nutrients may be dispersed into the soil. At the end of the shoe's lifetime as athletic footwear, it may be designed to, itself, biodegrade back into the soil from which it came, nourishing a garden, perpetuating natural resource cycles, and subverting environmentally destructive toxic waste cycles. In contrast to wasteful consumer product life cycles, energy here is converted from seeds (potential) to growth of the shoe (chemical) to athletic performance (kinetic) which, in turn, repurposes energy from the wearer's motion into seed dispersion and, ultimately, is returned naturally to the environment. Such eco fibers that form the shoe and provide eco functions may include plant-based matter, seeds, nutrients, natural fibers (e.g., cotton, hemp, flax, wool) and/or other living matter. Such fibers are biocompatible, environmental responsiveness and provide for spatiotemporal adaptation and/or regeneration.

Matter/Bio Wearer

A biological (Bio) wearer may be viewed as an apparel wearer with improved performance due to use of apparel, such as shoes, made from intelligent fibers. The biological (Bio) wearer unites the environment with the body through the medium of biological matter. Athletic performance may be augmented by functionally optimizing the material properties of footwear at the bio-molecular level. There are two primary mechanisms for optimization: (1) the plants selected as material components may be genetically engineered and (2) the environmental factors present during growth (such as temperature, humidity, light, and airflow) may be tuned. These ultimately affect the material distribution, volume-to-weight ratios, sponginess, and springiness of the plant-based product, all of which may serve to minimize energy loss due to poor gait biomechanics or maximize musculoskeletal health of the wearer. Bio fibers for providing such bio functions that form the shoe may further include hydrogels (e.g., sodium alginate), organic matter, biopolymers, bio-composites, and/or plant-based matter, for example. Such fibers allow for enhanced wearer performance where the physical properties of the shoe may be tuned via controlling environmental and nutritional conditions of a plant producing the plant-based fibers or fiber components, or via genetic engineering, augmentation, modification, or, preferably, regulation in a scientific laboratory for the purposes of controlling gene expression during growth and during the shoe's lifetime as athletic footwear.

Such data, eco, and bio intelligent fibers may include various types of fibers, made from various material, to sense different stimuli, to react and provide various outputs including communicating with each other and/or with further devices, such as communication and/or control devices, for example. Further, one or more types of fiber configurations may be implemented, such as mono-material fibers, coaxial fibers, and continuous fibers.

Such intelligent fibers, such as categorized above as data, eco and bio fiber, have different fiber architectures and digital fabrication methods as follows:

Fiber Architectures

Mono-Material Fibers

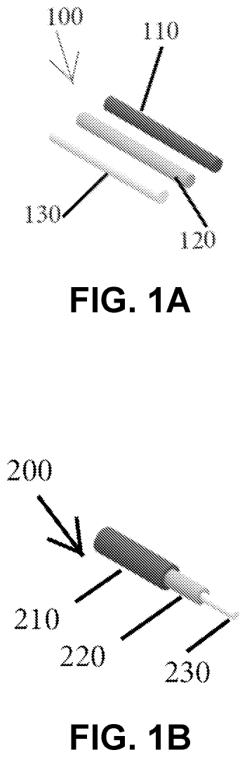

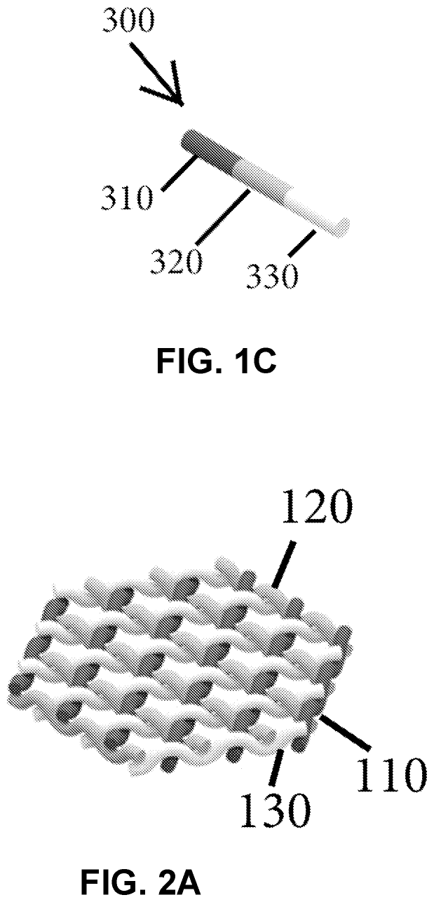

In one embodiment, each fiber comprises a single, distinct material. This enables spatial differentiation and independent directionality as a result of the textile pattern, which may be computationally designed. FIG. 1A shows the fiber structure 100 of three mono-material fibers 110, 120, 130, where each mono-material fiber 110, 120, 130 has a single, distinct material having different functionality from the material of the other two fibers. Each of the three mono-material fibers 110, 120, 130 are made from different material. For example, fiber 110 may be made of the data material typology, fiber 120 may be made of the biological material typology, and fiber 130 may be made of the eco material typology. It should be understood that different materials may include the same or similar material but modified or doped to change their properties. In one embodiment, each mono-material fiber 110, 120, 130 may have different degrees of the same functionality (e.g., varying degrees of elasticity, tensile strength, stiffness, weight, density, chemical resistance, heat resistance, thermal expansion, conductivity, antibacterial properties, color).

In another embodiment, each mono-material fiber 110, 120, 130 may have different functionalities, where, for example, the material fiber 110 may provide a first function (e.g., a waterproofing function), the material fiber 120 may provide a second function (e.g., a protective function), and the material fiber 130 may provide a third function (e.g., an optical function). Exemplary waterproofing fibers are polytetrafluoroethylene (PTFE) and other hydrophobic synthetic fluoropolymers of tetrafluoroethylene for waterproofing. Exemplary protective coatings are epoxy resins and other polyepoxides, and exemplary optically clear polymeric optic fibers are made of polymethyl methacrylate (PMMA) to provide paths of high transmission of light or lensing effects.

One or all of the first, second and third functions may be varied based on different external stimuli, such as temperature, humidity, or lighting levels. Other exemplary functions of the first, second and third fibers may include data transmission, electroluminescence, chemiluminescence, photoluminescence, energy storage (e.g., solar), sensing (e.g., capacitance, stretch, pressure, bending, resistance, strain), and providing spatially differentiated, directional material properties and functionality to the global textile (e.g, stretches more along the length of the first fiber than the length of the second fiber), such as those demonstrated in the following reference: Nguyen et al, 2021. Wearable Materials With Embedded Synthetic Biology Sensors for Biomolecule Detection. Nature Biotechnology, 39(11), pp. 1366-1374.

Coaxial Fiber

Another embodiment of the intelligent fiber is a coaxial fiber 200 shown in FIG. 1B, where each fiber 210, 220, 230 comprises multiple distinct materials in concentric shells. This enables all materials to follow the same continuous path through 3D space, though each material may be effectively turned ‘on’ or ‘off’ at any given point along that path, possibly resulting in exposure of inner shells, as shown in FIG. 1B. The three fibers 210, 220, 230 may be of similar types and have similar functions as the mono-material fiber 110, 120, 130. That is, the material fiber 210 may provide a waterproofing function, the material fiber 220 may provide a protective function, and the material fiber 230 may provide an optical function, for example. One or all of the these three functions may be varied based on different external stimuli.

Continuous Fiber

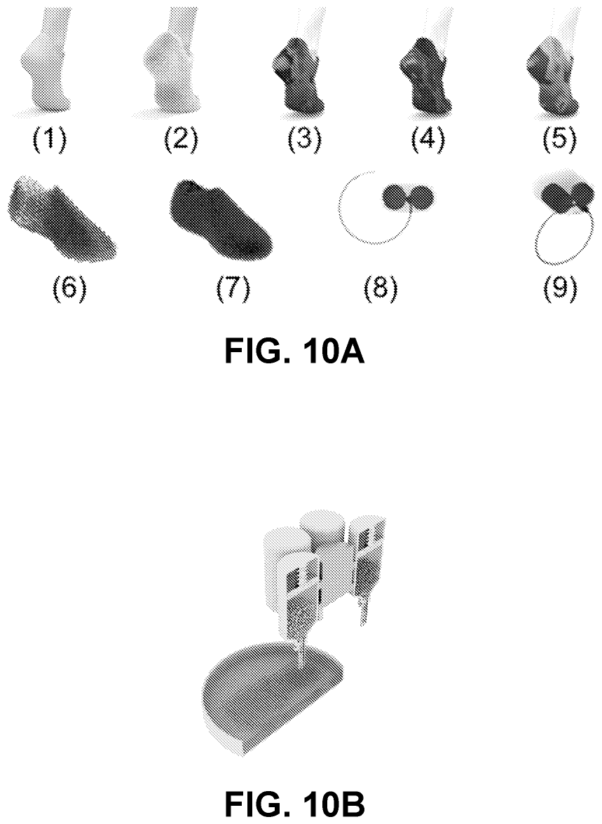

Another embodiment of the intelligent fiber is a continuous fiber 300 shown in FIG. 1C, where each fiber comprises multiple distinct or blended materials in series along its length, such as first, second and third material 310, 320, 330, being of similar types and having similar functions as the mono-material fiber 110, 120, 130. That is, the material fiber 310 may provide a waterproofing function, the material fiber 320 may provide a protective function, and the material fiber 330 may provide an optical function, for example. One or all of these three functions may be varied based on different external stimuli. The continuous fiber 300 enables materials to form a continuous gradient, or gradient with discrete boundaries. The distribution of the different fiber materials in this embodiment may vary in a regular or random fashion. The fibers, e.g., may be oriented co-axially or in segments as illustrated in FIG. 10. Alternatively, the fiber materials may be uniformly or randomly distributed in the intelligent fiber.

Digital Fabrication Methods

Three primary methods of making these fibers emerge where the digital fabrication method may be selected based on material parameters, such as triaxial weaving, 3D printing and electrospinning. Other fiber fabrication and fiber deposition strategies may easily be applied, including airflow-based spinning, rotor spinning, and carding. The workflow for each process incorporates desired material properties (e.g., color, texture, strength, flexibility, breathability) and/or environmental properties (e.g., temperature and humidity during digital fabrication, USDA hardiness zone of wearer's primary location) into virtual models to provide material composition and shape at the very beginning of the digital design and fabrication workflow, reversing the traditional sequence of shape design before material choice. A data-driven computational design framework guides material distribution and patterning in multi-material fiber production processes as follows. In certain embodiments, non-woven textiles may be obtained.

Details of triaxial weaving can be found in the following references: Kueh et al., 2007. Triaxial Weave Fabric Composites.; and Bilisik, K., 2012. Multiaxis Three-Dimensional Weaving for Composites: a review. Textile Research Journal, 82(7), pp. 725-743.

Details of 3D printing of fibers and textiles can be found in the following references: Chatterjee, K. and Ghosh, T. K., 2020. 3D Printing of Textiles: Potential Roadmap to Printing with Fibers. Advanced Materials, 32(4), p. 1902086; and van der Elst et al, 2021, 3D Printing in Fiber-Device Technology. Advanced Fiber Materials, 3(2), pp. 59-75.

Details of electrospinning techniques can be found in Schiffman, J. D. and Schauer, C. L., 2008. A Review: Electrospinning of Biopolymer Nanofibers and Their Applications. Polymer Reviews, 48(2), pp. 317-352; and Mirjalili et al., 2016. Review for Application of Electrospinning and Electrospun Nanofibers Technology in Textile Industry, Journal of Nanostructure in Chemistry, 6(3), pp. 207-213.

Triaxial Weaving

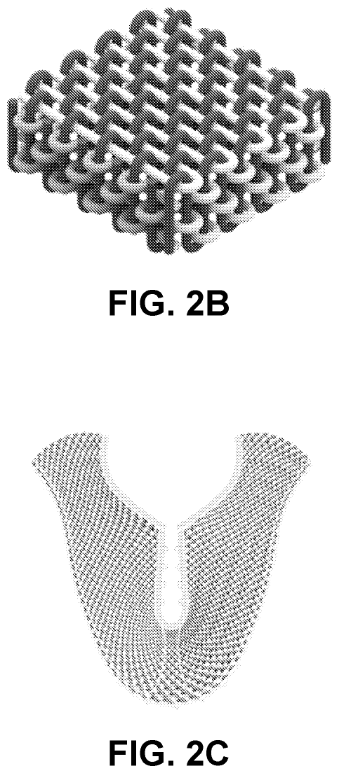

As shown in FIGS. 2A, 2B, in one embodiment, three mono-material fibers 110, 120, 130 may be triaxially interwoven in various patterns on a robotic loom to optimize for strength-to-weight ratio and breathability across the fabric. The triaxially interwoven fibers may form an unfolded shoe, as shown in FIG. 2C which may subsequently be joined along at least one seam to itself or to another component, such as a shoe sole, through processes such as controlled evaporation.

Fibers can be triaxially woven according to weaving methods as described in the following references: Adanur, S., 2020. Handbook of Weaving. CRC Press; and Bilisik, K., 2012. Multiaxis Three-Dimensional Weaving for Composites: A Review. Textile Research Journal, 82(7), pp. 725-743.

3D Printing

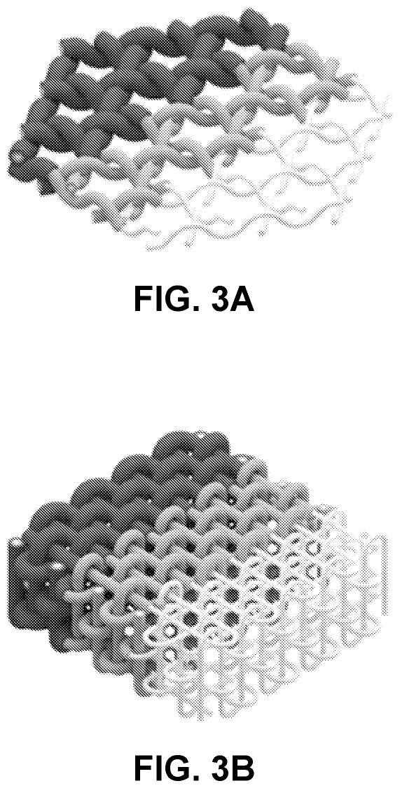

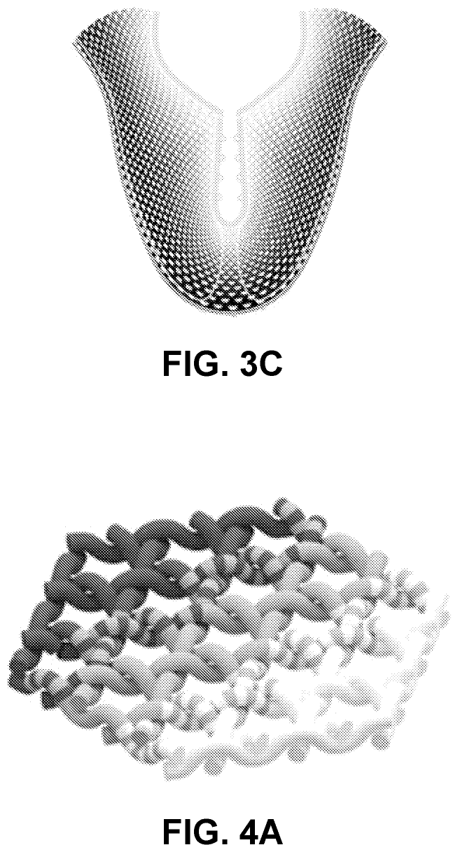

In another embodiment, as shown in FIGS. 3A, 3B, a single coaxial fiber may be extruded with multiple materials in concentric shells to combine the unique properties of each material across structures with complex three-dimensional (3D) geometries. The 3D printed coaxial fibers may be woven to form a textile in the pattern of an unfolded shoe, as shown in FIG. 3C which may subsequently be joined along at least one seam to itself or to another component, such as a shoe sole; or it may be flexible with a capacity to adapt to the surface topology of a body or 3D shape such as a foot, either through mechanical folding or by other physical methods of material arrangemen through processes such as controlled evaporation. Accordingly, articles may obtained by 3D printing using direct textile printing in which fibers are deposited by lagers in orthogonal directions, and then crosslinked through thermal, mechanical or chemical bonds to provide warp-weft-like or woven-like mechanical properties. Alternatively, in secondary textile creation, fibers can be extruded and isolated or twisted and made into yarn or thread spools. The spooled thread can be feed into a weaving loom which feeds the thread through weft and warp throughout the assembly process to provide a textile. Combinations of these techniques are possible, for example, a part of an article may be directly 3D printed while another part is woven from a 3D printed fiber.

Three-dimensional printing of fibers and textiles is described in the following references: Chatterjee et al., 2020. 3D Printing of Textiles: Potential Roadmap to Printing with Fibers. Advanced Materials, 32(4), p. 1902086; and van der Elst et al., 2021. 3D Printing in Fiber-Device Technology, Advanced Fiber Materials, 3(2), pp. 59-75.

Electrospinning

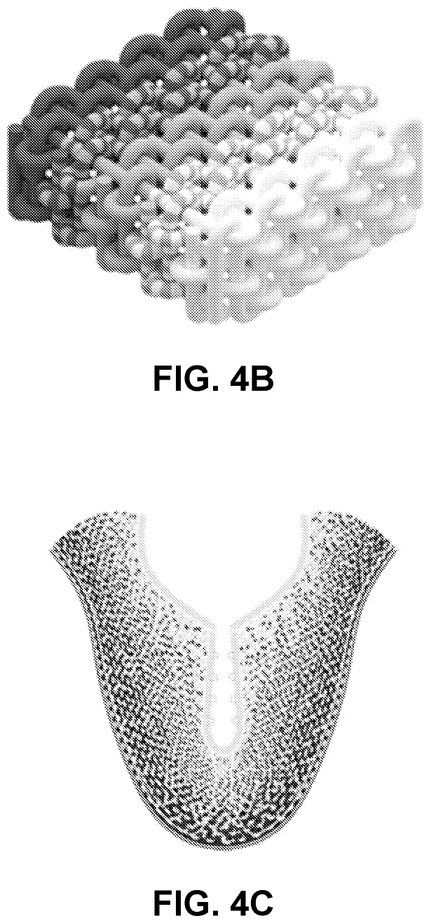

In another embodiment, as shown in FIGS. 4A, 4B, a single, ultrafine, continuous fiber with varying material composition along its length may be spun by drawing out a polymer melt or solution through an electric field, for example, and subsequently woven into a textile. The spun fiber may be smooth, ribbon, aligned, beaded, core-shell or hollow in morphology. For ecological friendliness, electro-spun fibers may be prepared from biopolymers such as cellulose, chitosan, and the like. The electro-spun fibers may be woven into a textile to form an unfolded shoe, as shown in FIG. 4C which may subsequently be joined along at least one seam to itself or to another component, such as a shoe sole; or it may be form-found through processes such as controlled evaporation, for example.

Electrospinning of fibers and their weaving into a fabric is discussed in the following references: Schiffman et al., 2008. A Review: Electrospinning of Biopolymer Nanofibers and Their Applications, Polymer Reviews, 48(2), pp. 317-352; and Mirjalili et al., 2016. Review for Application of Electrospinning and Electrospun Nanofibers Technology in Textile Industry. Journal of Nanostructure in Chemistry, 6(3), pp. 207-213.

From Fiber to Product

Material typologies, fiber architectures, and fabrication methods may be combined in various permutations to achieve desired performance, color, texture, or other material properties and functionalities toward the production of not just a piece of fabric but even a whole product or structure. For the purpose of concise description, a shoe fabrication will be described from these fibers, but it should be understood that such invention extends to digital fabrication of other garments, textile products, structures, tangible goods, building materials across scales and/or other products. It should also be understood that fabrication of a product may comprise mono-material fibers, coaxial fibers or continuous fibers, individually or in any combination.

Examples of how a fabric shoe is manufactured can be found in the following reference: Cheah et al., 2013. Manufacturing-Focused Emissions Reductions in Footwear Production. Journal of Cleaner Production, 44, pp. 18-29.

Photosensitive Shoe

The 3D printed fibers can be used to transmit light or to provide a particular aesthetic to the final product. In one embodiment, a 3D printed coaxial fiber comprises a plurality of layers, such as two, three, or more layers. In an embodiment of a fiber having three layers, the innermost layer of the fiber may be a data core, such as a bundle of flexible, transparent glass (silica) optical fibers, for example, each drawn to 9 μm and configured to transmit light. The innermost layer is surrounded by a middle layer, such as a functional photopolymer resin, which both protects the data core and may respond to the visible light traveling through it by changing its structural and chemical properties, preferably reversibly. The outermost layer is pigmented, for example, a plant-based rubber infused with natural pigments, so that the fibers have a durometer and pigmentation that can be varied to optimize both performance and aesthetics. In an alternative embodiment, a particular layer of the fiber can be colored or transmit a color, and another layer can be clear or transparent, thereby providing the fiber with a particularly desired color.

Biomechanics-Informed Design

In another embodiment, a CT or MRI scan of a wearer's foot is used to generate a 3D model, which is used to calculate the global foot geometry and tissue properties, such as impedance, a function of soft tissue depth, distribution, density, viscoelasticity, etc. The foot geometry and tissue properties may be used in combination with pressure maps of the foot while standing, walking, and/or running to guide the design of a custom-fit shoe with spatially varying properties, such as, e.g., material thickness, stiffness, porosity, based on anatomy and biomechanics. Such a shoe may be triaxially woven with fibers of different properties (such as shore hardness, shock absorption) that may be precisely distributed according to computational design with an objective function of minimizing impact on bones, minimizing energy loss through the shoe, and/or minimizing energy loss due to non-optimal gait biomechanics. Such a shoe provides substantial advantages over existing technology such as increased strength-to-weight ratio, and/or high-resolution multi-property material distribution. Multi-material fiber with capacity of pressure sensing can be achieved for example if assembling two fibers made of a conductive material and separated by a dielectric either in a concentric arrangement or in a parallel arrangement. When such combination fiber is pressed or stretched, the distance between the conductive fibers will change and therefore the capacitance measured in between the conductive fibers. This is analogous to how planar pressure capacitance sensors operate, but with a 2-rod conductive arrangement versus 2-panes. Such features are discussed in The Journal of Physical Chemistry C 2018 122 (29), 16964-16973

Biomechanics Response

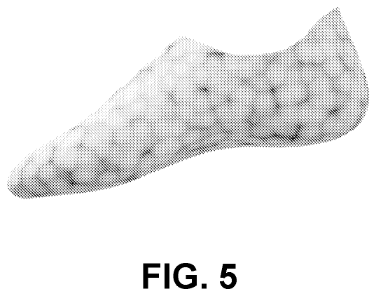

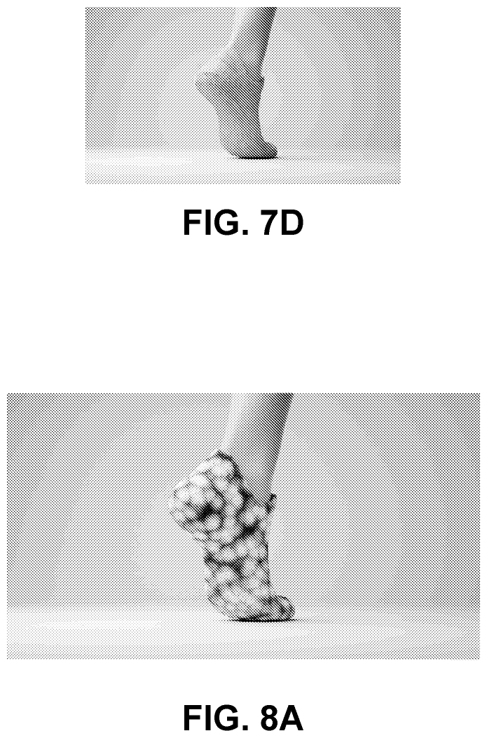

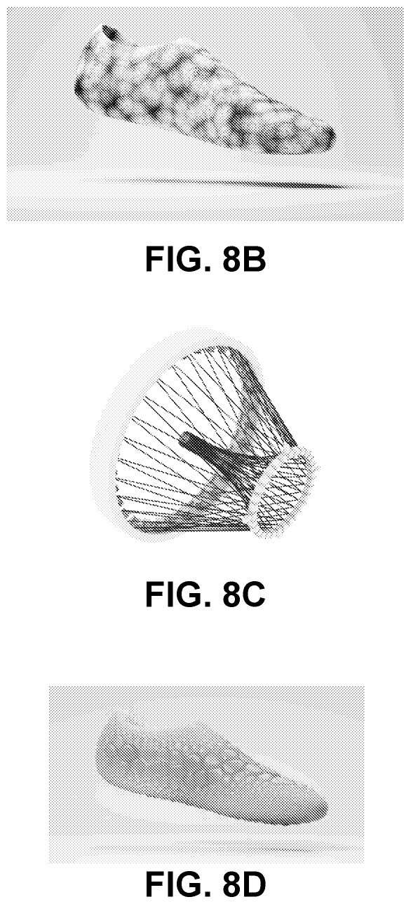

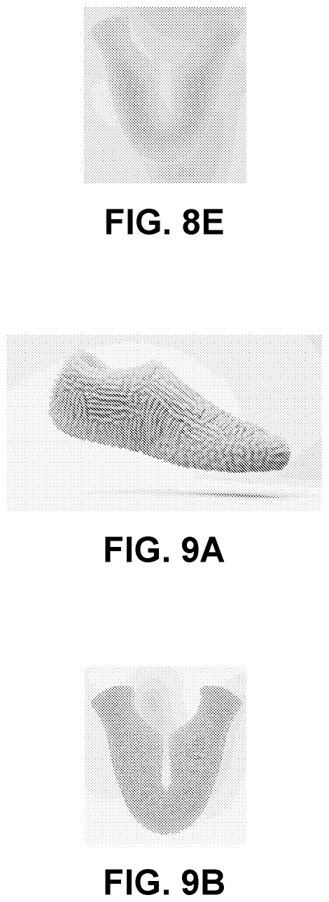

The above Biomechanics Detection shoe may alternatively or additionally trigger real-time responses in itself. For example, the force-sensing optical fibers may be distributed across an inner layer of the shoe and be linked to an actuated outer layer comprising two related parts: (1) a mesh of fibers 3D printed along Voronoi grid lines as shown in FIGS. 5, and (2) 3D printed cells that may inflate to form air chambers (as shown in FIG. 8D) through the gaps in the grid. The air chambers may be 3D printed from liquid silicone rubbers, for example. In use, the air chambers may individually inflate based on sensed ground reaction forces and other data in order to provide spatially tuned cushioning.

Breathing Shoe (Bio-Oriented)

To form or manufacture a breathing shoe, that is, a shoe that is porous and ventilated, a plume of biopolymer nanofibers may be electrospun. Microporous electrospun fibers and membranes are inexpensive, lightweight, and protective, with tunable pore size affecting air permeability or breathability so that larger pores provide a greater degree of ventilation of the foot, while smaller pores provide a lesser degree of ventilation. Such fibers may be triaxially woven together with at least one material that senses moisture and/or heat, both from the environment and the foot. An example of a temperature-responsive (thermochromic) material is hydroxypropylcellulose, and the following reference discusses the use of hydroxypropylcellulose for similar applications: Chiang, F. B., 2016. Temperature-Responsive Hydroxypropylcellulose Based Thermochromic Material and its Smart Window Application. RSC Advances, 6(66), pp. 61449-61453. In response to high moisture, the breathable electrospun material may undergo shape deformation, such as actuated by a material that selectively contracts and/or expands in response to the moisture conditions, generating a wrinkling effect that increases surface area of the porous material, as shown in FIG. 9A, to regulate breathability, temperature, permeability, perspiration to reduce sweat, for example. FIG. 9B shows a mesh of such electrospun fibers forming an unfolded shoe.

Iridescence

The fibers may also be made from material exhibiting iridescence. For example, plant-derived cellulose fibers may be woven into the global form of a shoe. This form is computationally designed based on the material properties of the fibers. The local fiber geometries are precisely designed and woven to yield specific colors, light scattering, and/or iridescence similar to feathers of a blue jay, for example. Iridescence can be achieved in many biological and non-biological materials such as Polyester by depositing a film of material with refractive index on top of another with higher refractive index at a distance which contributes to the generation of constructive or destructive interference of incident light constitutive wavelengths. Similar effects have already been demonstrated in iridescent polyester fibers and also in fibers containing a liquid crystal core. Alternatively or in addition, an iridescent material such as mica can be added to a clear polymer to provide iridescence to the fibers. Such features are discussed in “Biomimetic Chiral Photonic Crystals”, Angew. Chem. Int. Ed. 2019, 58, 7783.

Data Collection Shoe

A shoe made from intelligent fibers may be configured to collect environmental data. For example, the fibers of the shoe can be embedded with sensors for biomolecule detection, such as CRISPR-based wearable freeze-dried cell-free sensors enable direct nucleic acid detection of bacteria such as Staphylococcus aureus and viruses such as SARS-CoV-2, as well as small molecules such as theophylline. When the shoe comes in contact with the DNA, RNA, protein, small molecule, or other substance, the shoe can provide a colorimetric result to indicate the presence of the substance being monitored. Such analyses are described in as described by Nguyen, Soenksen, et al. Nature Biotechnology, 2021, 39, 1366-1374. In further embodiments, the shoe can be configured to collect soil samples in compartments in the bottom sole as the shoe is worn, and after an appropriate amount of time or distance, the shoe can be removed and analyzed to determine the composition of the collected soil.

Dynamic Coloration

A shoe made from intelligent fibers may be configured to provide dynamic coloration. For example, a battery-powered flexible LCD screen containing mechano-chromic or electro-chromic molecules may be embedded in a shoe and the shoe may provide dynamic coloration upon receipt from an applied voltage from a processor. If a sensor in the shoe or sole detects an input such as moisture, high or low pH, humidity, the processor will cause the LCD to display a particular coloration pattern and thereby provide

Chemiluminescence

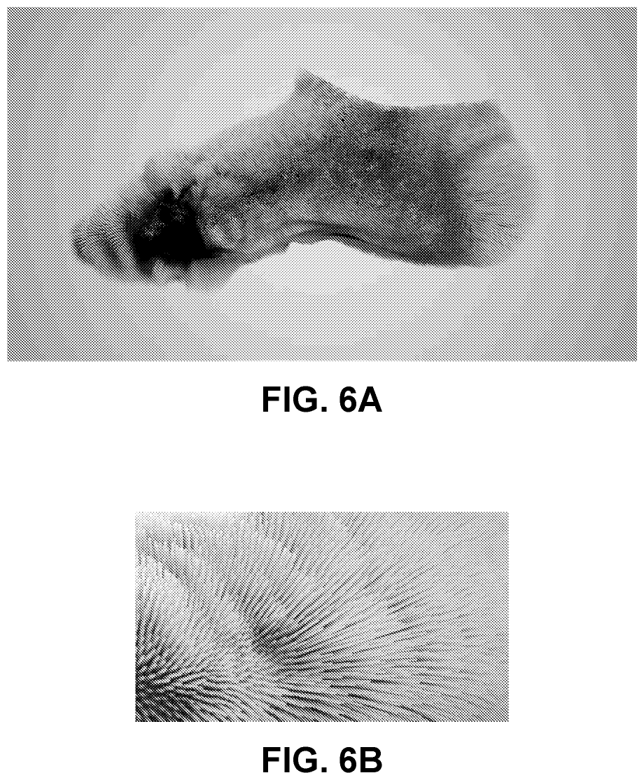

Each porcupine hair (such as shown in FIGS. 6A and 6B) is a 3D printed optical fiber and lights up at night. In particular, a light sensor detects low light condition, where light intensity or brightness surrounding the shoe is below a predetermined level. In response to detecting such lighting condition being below a predetermined threshold level or outside a predetermined range, fibers including luminescent material may be activated such as by applying a voltage, thus providing light. Any desired color and/or intensity may be provided such as by adjusting the voltage level. Alternatively. luminescence can be activated manually. Luminescence can be provided by compounds such as nanoluciferase, as described by Nguyen, Soenksen, et al. Nature Biotechnology, 2021, 39, 1366-1374.

Intelligent fibers and products made from intelligent fibers have many benefits. For example, sensing and actuation are achieved with increased resolution and at the cellular and/or micro or local level, enabled by the bio-based materials of the intelligent fibers and their methods of fabrication and weaving into products as described. Further, such intelligent materials fully leverage bio-mechatronics, where the biological and/or ecological element of the intelligent fibers differentiate them from conventional computational fabrics. In addition, the digital fabrication and manufacture of the intelligent fibers and products made therefrom use less energy and fossil fuels, as well as produce less toxic waste byproducts and may biodegrade without harming the environment. Such intelligent fibers unlock a new set of material properties that cannot be matched by conventional synthetics.

Intelligent fibers further allow for computational design of material structures (geometry and/or form) based on material parameters, such as color, raw material, texture and/or performance, for example.

Moreover, the intelligent fibers may be used with different fabrication methods selected based on material parameters, for example.

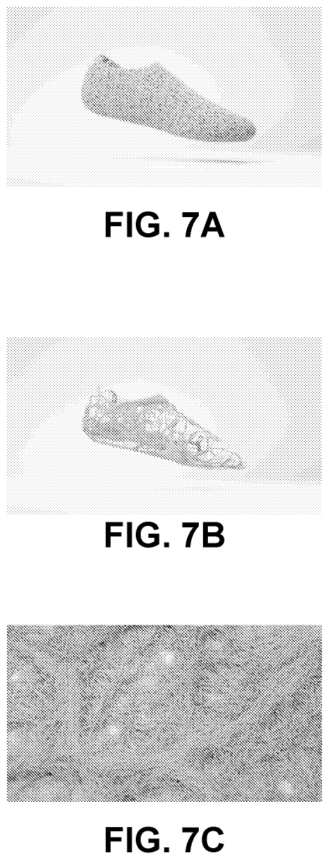

In an illustrative embodiment, a shoe is fabricated from intelligent fibers using methods such as melt electrospinning. A biopolymer melt, comprising natural fibers such as cotton, is fed into a spinneret mounted on an actuated arm (such as a 3-axis gantry typical of a 3D printer, or a 5- or 6-axis robotic arm), such as shown in FIG. 7A. A second polymer melt, comprising additives such as a pigment or gold nanoparticles, may be fed into a second spinneret mounted on the same or different actuated arm, such as shown in FIG. 7B. A high electric potential is applied between each spinneret tip and a metal collector to propel micro- to nanoscale fibers through cooled air and onto the last along user-specified toolpaths generated to form a geometry, such as shown in FIG. 7C, that may have been computationally designed to provide a certain flexibility, color, strength, breathability, and other material properties to the shoe by varying extrusion rate, temperature, infill density, material composition, and other parameters. In addition to the tunable geometry, the biopolymer melt may vary material composition over time, effectively generating the continuous fiber described herein.

The collector may be in the form of a 3D last for a shoe, where a last is a 3D mechanical form or mold shaped like a human foot upon which the shoe is constructed. The collector in the form of the 3D last for the shoe may be solid, as in conventional lasts, such that the end product is a shoe, such as shown in FIG. 7A, which has the advantages of being composed of natural fibers, seamless, lightweight, breathable, and highly predictable in its form and function, using a highly automated process with minimal waste. The collector may alternatively take the form of a 3D lattice of data fibers, bio fibers, or eco fibers in the general form of a last, such as shown in FIG. 7B. This results in a shoe which encases one level of functional fibers in a second electrospun layer of functional fibers. The collector may instead be in the form of a 2D metal plate, such that the end product is an unfolded shoe, such as shown in FIG. 8E. In this case, the unfolded shoe may be formed into a shoe shown in FIG. 7D, such as the unfolded shoe being joined along at least one seam to itself or to another component, such as a shoe sole; or it may be form-found through processes such as controlled evaporation.

In another embodiment, a shoe is fabricated from mono-material fibers using methods such as triaxial weaving or braiding. The fibers may be woven over any mandrel form, such as a mold (e.g., uniform, such as cylindrical, or varying cross section, such as a shoe last) which may subsequently be removed or the fibers may be woven over a structure which may comprise another layer of the shoe. For example, a layer of inflatable cells may first be fabricated by methods such as 3D printing air chambers from liquid silicone rubbers suspended in hydrogel to form Voronoi tessellations, as shown in FIGS. 8A-B. This layer may be supported on a mandrel, such as shown in FIG. 8C, during a subsequent braiding operation in which intelligent fibers are woven around the inflatable layer in a pattern that may be computationally designed to optimize the functionality of the shoe. For example, surface-based Voronoi tessellation may be applied to the 3D woven structure, as shown in FIG. 8D, having inflatable bubbles in a 3D printed fiber scaffold offering spatially differentiated cushioning and higher resolution around features of increased curvature, for example. Voronoi tessellation is a numerical algorithm to divide a spatial domain into completely interlocking cells which tessellate to form the original domain. The air chambers, as shown in FIG. 8D, may be inflated within this supporting and spatially differentiating woven structure. Inflation may be predetermined, such that the chambers are inflated to specific degrees prior to wear and preferably based on biomechanical analysis of the wearer's gait and anatomy. An example of an insole for wireless gate analysis can be found in Talavera et al., 2015, December. Fully-Wireless Sensor Insole as Non-Invasive Tool for Collecting Gait Data and Analyzing Fall Risk. In Ambient Intelligence for Health (pp. 15-25). Springer, Cham.

Inflation may passively or actively respond to stimuli. For example, the air in the chambers may heat and expand in response to higher environmental temperatures, causing the woven layer to stretch, reducing its density and thereby increasing breathability of the shoe in hot weather. In an active example, the shoe may comprise one or multiple pressure sensors on the inner surface of the shoe that detect ground reaction forces; the air chambers may then be actuated to inflate, in a manner that provides spatially differentiated cushioning around the foot. The woven layer may also passively or actively respond to stimuli. For example, the woven layer may comprise materials that shrink or contract in response to water, effecting shape deformations in the underlying layer. An example of a hygroscopic film material that could be used for this specific feature can be found in: Zhang et al., 2020. Super-hygroscopic film for wearables with dual functions of expediting sweat evaporation and energy harvesting. Nano Energy, 75, p. 104873.

Weaving of intelligent fibers may instead occur in 2D, such that the end product is an unfolded shoe, as shown in FIG. 8E. In this case, the unfolded shoe may subsequently be joined along at least one seam to itself or to another component, such as a shoe sole; or it may be form-found through processes such as controlled evaporation.

The air chambers may be distributed and located at any desired distribution or location, and may be any desired shape and size, mixed and dispersedly formed throughout the shoe.

FIGS. 9A and 9B show another embodiment having elongated air chambers where material deformations may be based on reaction diffusion systems which increase surface area.

In another embodiment, a shoe is fabricated from intelligent coaxial fibers using methods such as, voxel-based multi-material 3D printing. In this case, the shoe may be considered in two parts, though these parts are preferably seamlessly united and fabricated in the same process. One part may be referred to as the ‘liner’, such as a millimeter-scale membrane that interfaces with and generally follows the external geometry of the foot. The liner may be solid or porous, in the form of a grid such as Voronoi cells, or in any other form that generally allows for encasement of the foot and supports the fiber structure.

From the liner, an array of fibers extends transversely with respect to the surface of the foot, like a hair (though the fibers may also be printed such that each extends longitudinally or at any angle or direction). The array of fibers, including their individual material properties, lengths, diameters, cross-sectional shapes, stiffnesses, etc. may be computationally designed to optimize the shoe performance. Each fiber originates from an origin point on the liner and terminates at a user-specified length, preferably from 0.1 mm to 300 mm from origin point to terminal point. The fiber(s) may extend much longer than this origin-to-termination length, such that it traverses the liner or even interweaves with other extended fibers to comprise and/or surround the liner in full or part to form a modified liner. Each fiber has functional capabilities, including sensing, actuating, or both. For example, the fiber may respond to environmental stimuli, including mechanical, chemical, biological, optical, gustatory, thermodynamic, electronics, electromagnetics, etc. The fiber may also change, create, form and output some mechanical, chemical, optical, or other output, including change of orientation, diameter, stiffness, color, length, texture, etc. A fiber comprising organic materials, including plant-based material and living organisms such as bacteria, may be engineered to have certain gene expressions based on stimuli. A fiber may comprise conductive materials, insulating materials, semiconducting materials, microelectronic, polymeric, metallic, piezoelectric, capacitive, ceramic, composite, biocomposite, hydrogel, liquid, gas, solids, etc. A fiber may have functionalities including electroluminescence, chemiluminescence, photoluminescence, energy harvesting or storage (e.g., solar). It may be impregnated, for example with a resin, or coated, for example with a biological enzyme.

For example, the innermost layer of the coaxial fiber may be a data core, such as one or more flexible, transparent glass (silica) optical fibers each drawn to 9 μm and able to transmit light. This may be surrounded by a shell comprised of an ecological material, such as a functional photopolymer resin, which both protects the data core and may respond to the visible light traveling through it by changing its structural and chemical properties. Such changes may be reversible, such as when the stimulus causing the change is removed and/or a further stimulus is provided to, or received or detected by, the fibers. The outermost layer may be a shell comprised of a biological material, such as a plant-based rubber infused with natural pigments whose durometer and pigmentation can be varied to optimize both performance and aesthetics.

Where power storage or an energy source is needed, it may be provided via an embedded standard battery that can be wirelessly charged or by harvesting Bluetooth™ WIFi™ radio, and other wireless signals. One or more of the fibers themselves may serve as a battery, comprising a 3D printed electrically and ionically conductive materials surrounded by an insulating shell. The fibers may also be configured to exchange and transfer data, to store information thus act as a memory, as well as reversible change and/or provide outputs to other fibers or system elements such as in response to stimuli thus acting as microcontrollers and microprocessors, for example. Alternatively or in addition, further microcontrollers and/or microprocessors (processors) may be included in the system, such as attached to and/or embedded in the fibers, where the processor(s) may be operatively coupled, such as by wired or wireless connections, with other elements of the system and any other desired element. For example, signals from the processor(s) may be provided to a renderer, such as a display and/or printer external to the product or shoe, such as a display on a wrist band of the wearer of the shoe, or a display/printer of a remote terminal used by a remote user such as a coach of an athlete or a medical professional of a patient, for remote monitoring and/or control of the product (such as the shoe), for example.

The shoe may be 3D printed in a gel medium, which can then be removed by dissolving or other mean, for support during fabrication. The shoe may be 3D printed on a flat substrate, as in conventional 3D printing, such that the end product is an unfolded shoe. In this case, the unfolded shoe may subsequently be joined along at least one seam to itself or to another component, such as a shoe sole; or it may be form-found through processes such as controlled evaporation.

FIG. 10A shows illustrative stages of a shoe starting from a base or liner which is modified by fibers to form a desired geometry with desired material and chemical distribution based on a modeled response. The shoe may be tested and compared with the modeled response and modified as needed to from a shoe having the desired modeled response. In FIG. 10A, the base features (1) and geometry (2) of a shoe are shown. Material distribution (3), chemical distribution (4), and the modeled response (5) can be modeled so as to provide a shoe with the desired characteristics. Volumetric material distribution (6) and droplet deposition distribution (7) can also be modeled. A bio-augmented photopolymer resin (8) and multi-material 3D printing (9) can be utilized to prepare the fibers to ultimately obtain the desired product (as further discussed herein).

FIG. 10A also shows volumetric material distribution and droplet deposition using different material deposited by 3D printing, such as bio-augmented photopolymer resin. The bio-augmented photopolymer resin may be deposited by 3D printing via conventional methods known in the art, such as standard commercial 3D printers configured for fused deposition modeling, preferably with multimaterial voxel-based 3D printing methods (also referred to as bitmap 3D printing). Multimaterial voxel-based 3D printing is shown in FIG. 10B. More than one type of material may be printed simultaneously via multi-material 3D printing, of bio-augmented photopolymer resin and the resulting intelligent fibers that may include nutrients and seed, that may grow when the shoe biodegrades and the seed and nutrients are released for germination and new plant growth.

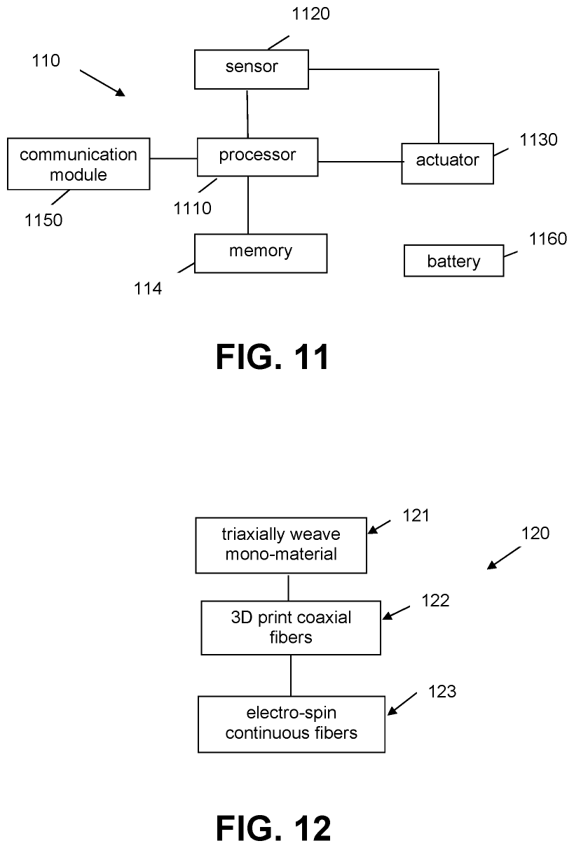

FIG. 11 shows a block diagram of a system 1100 according to another embodiment. The system 1100 may be a shoe and/or any other textile product and/or clothing made from the described intelligent fibers. As shown in FIG. 11, a processor 1110 is operatively coupled to at least one sensor 1120. The sensor(s) 1120 may be the plant-based intelligent fibers themselves, embedded in the them and/or external to them and located at one or more positions throughout the product. Such sensor(s) 1120 may be any desired type of sensor(s), such as light sensor, pressure sensor, temperature sensor, humidity sensor, sweat sensor, photoelectric sensor, heart rate monitor, blood oxygen sensor, stretch sensor, bend sensor, inertial measurement unit, accelerometer, gyroscope, position sensor, chemical sensor and/or motion sensor, for example. The processor 1110 may also be operatively coupled to at least one actuator 1130 which may be configured to be actuated in response to control signals from the processor 1100. The processor 1100 may be configured to monitor signals from the sensor 1120 and output control signals to the actuator 1130 for actuation in response to the sensed signals (received from the sensor 1120) where such sensed signals exceed a first predetermined level, are lower than a second predetermined level, and/or are outside a predetermined range.

Alternatively or in addition, the actuator 1130 may be actuated in response to a signal from the sensor 1120. For example, the sensor 1120 may be configured to output the signal when an environmental condition is outside a predetermined range, such as when the environment is too cold or too hot, too dry or too wet, dark or light, etc. The actuator(s) 1130 may be embedded in the intelligent fibers and/or external to them and located at one or more positions throughout the product. The actuator(s) 1130 may be any desired type of actuator, such as motor, pump, valve, spring, electrostatic, electromagnetic, piezoelectric, fluid, thermal and/or microactuator.

Further in this embodiment, a memory 1140 is operatively coupled to processor 1110 and (1) stores software modules, computer programs, algorithms or instructions when executed by the processor 1110, (2) causes the processor 1110 to perform various operational acts to monitor sensor signals from the sensor(s) 1120 and/or (3) provides actuation signals to the actuator(s) 1130. The memory 1140 may further be configured to store other instructions and various operational and/or measured/monitored data, such as values of predetermined thresholds and/or thresholds ranges used during operation of the system 1100, as well as data monitored by the various sensors 1120.

The sensor(s) 1120 and/or the actuator(s) 1130 may be distributed within the product and/or be part of the intelligent fibers. For example, the processor 1110 may be configured to provide a voltage to certain portions of the intelligent fibers to effectuate a desired response, such as light and/or color change, changing hardness/softness of the fiber portions by changing fiber elasticity, expanding/contracting fiber portions and/or inflating/deflating pockets in the fiber portions, for example.

The system 1100 may further include a communicator 1150 configured to provide communication among various elements of the system as well as with further elements, such as a remote server and/or remote processor through a network via wireless communication, such as Bluetooth™ and/or WIFi™, for example. The processor 1110 or a further remote processor may be included in a further wearable product, such as wristband, and/or included in a far remote or central location at or a different location of a remote server, for example. In addition, a user interface (UI) may be operatively coupled to the processor 1110 to allow user input. The UI may be included in the product in the form of an on/off switch for example, to turn on or turn off one or more functions of the system 1100, such as turning off a lighting or camouflage feature, for example. The UI may further be a touchscreen on a wristband or a keyboard and/or mouse located at the remote central location housing the further processor.

The communicator 1150 may be included in the various elements of the system 1100 and/or may be a separate element operationally coupled to at least one of the elements of the system 1100.

The system 1100 may further include other elements, such as a power source 1160, e.g., a battery which may be rechargeable, for supplying power to elements such as the processor 1110, sensor(s) 1120, actuator(s) 1130 and/or memory 1140. Similar to the communicator 1150. the battery 1160 may also be included in the various elements of the system 1100 and/or may be a separate element operationally coupled to at least one of the elements of the system 1100. For example, in response to signals from the processor and/or sensors, the battery 1160 may provide desired voltages which cause changes as desired, such as, e.g., at least one of changing color, texture, elasticity, cushioning and insulating features, and the like.

One or more of the various interconnected elements of the system 1100 may be operatively connected to a network, such as the Internet or a local area network, for communicating through the network with a remote server, a remote memory, a remote UI and/or a remote display, where the server may have its own processor, memory, UI and display. All or some parts or elements of system 1100 may be connected to the network and server, directly or indirectly, through conventional connections, which may be wired or wireless, such as via wire cables, fiber optics, satellite or other RF links, Bluetooth™. Similarly, the various elements of system 1100 may be interconnected, directly or indirectly, which may be wired or wireless, such as via wire cables, fiber optics, Bluetooth™, as well as long range RF links such as satellite. Thus, processor 1110, memory 1140, as well as other elements of system 1100 shown in FIG. 11 may be co-located near each other, and/or may be remote from each other and operationally coupled or connected through a local area network and/or the Internet through wired or wireless secure connections where communications therebetween may be encrypted, for example.

The various components of the system may be operatively coupled to each other via wired or wireless connections, such as Bluetooth™, Wi-Fi™ or any other radio frequency (RF) link, for example.

The processor 1110 may be a singular processor or a collection of distributed processors, such as having processors and/or controllers included with various system elements where, for example, the sensors, actuators, communication module and/or battery may have their own dedicated processor that, collectively with other distributed processors of system 1100, are referred to as processor 1110 of system 1100.

As illustrated in FIG. 12, a method 1200 of making a product from intelligent fibers comprises at least one of a step 1210 of triaxially interweaving mono-material fibers: a step 1220 of three-dimensional (3D) printing coaxial fibers; and a step 1220 of electro-spinning continuous fiber.

The software modules, computer programs, instructions and/or program portions contained in the memory may configure the processor to implement the methods, operations, acts, and functions disclosed herein. The processor so configured becomes a special purpose machine or processor particularly suited for performing the methods, operations, acts, and functions. The memories may be distributed, for example, between systems, clients and/or servers, or local, and the processor, where additional processors may be provided, which may also be distributed or may be singular. The memories may be implemented as electrical, magnetic or optical memory, or any combination of these or other types of storage devices. Moreover, the term “memory” should be constructed broadly enough to encompass any information able to be read from or written to an address in an addressable space accessible by the processor. With this definition, information accessible through a network is still within the memory, for instance, because the processor may retrieve the information from the network for operation in accordance with the present system.

Hybrid Plant Product Templates

Another aspect of the present invention is directed to hybrid plant product templates for containing and harvesting plant-based soles and apparel across scales.

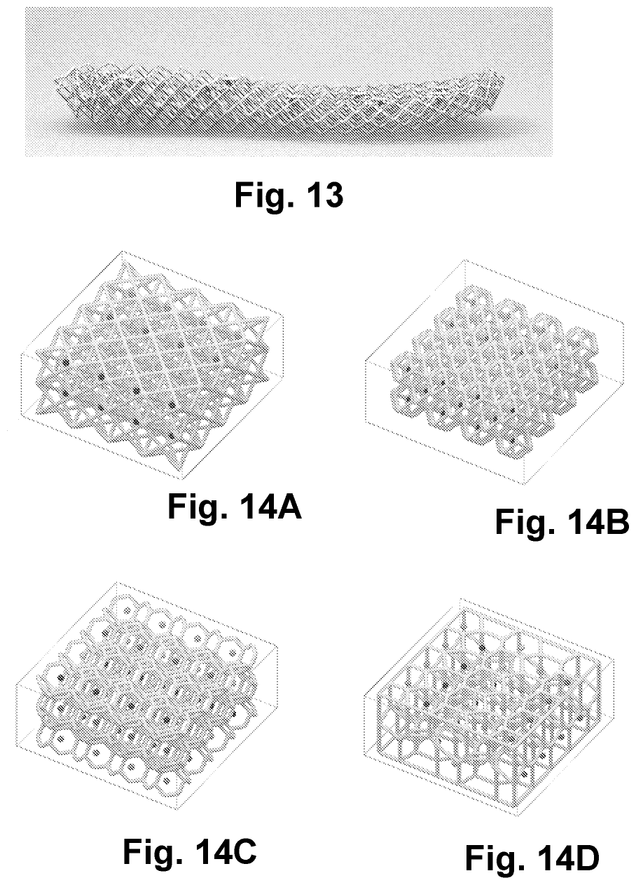

A hybrid plant product may include any type of plant-based product, such as a shoe, garment, tangible good, building structure, or other product, device, or article, that has been fully or partially grown in a laboratory. For example, a propagative plant structure such as a seed, spore, or fruit may be grown in a specialized controlled environment. For ease of discussion herein, seeds will be used to exemplify the source of plant material, although the term “seeds” should be interpreted broadly to include any kind of plant tissue such as spores, grafts, shoots, sprouts, undifferentiated plant cell tissue, or other tissues that grow to provide a plant. A hybrid plant-based product template is a material and/or environmental structure on or in which the hybrid plant product is grown. FIG. 13 shows an embodiment of a hybrid plant product template in the form of the sole of a shoe for growing a hybrid plant product, as further discussed below. A system for growing a hybrid plant product in a hybrid plant product template is discussed in in applicant's co-pending PCT patent application entitled “Methods and Apparatus for Bio-Regulation and Templating of Plant Growth Within a Controlled Growth Capsule for the Production of Augmented Bio-Consumables”, filed on even date herewith and incorporated herein by reference in its entirety.

FIGS. 14A-14D show embodiments of hybrid plant product templates for containing and harvesting plant seeds within plant-based soles and apparel. A hybrid plant product template is a 3D volumetric space, and may be referred to one environmental pixel or growth module. The hybrid plant product templates may have any type of configuration which can contain and grow a plant. In an exemplary embodiment, a pixel of a hybrid plant template may have dimensions of 3⅝ inches×3⅝ inches×1⅝ inches (9.2 cm×9.2 cm×4.1 cm), while in other embodiments, a pixel (or other repeating unit) may have different dimensions. The hybrid plant product templates may be prepared via 3D printing as is known in the art.

In FIGS. 14A-14D, the spheres in the cavities represent possible locations for plant seeds or plant tissues. Depending on the particular implementation and embodiment, seeds may be planted in any appropriate pattern, for example, in each cavity, in alternating cavities, in alternating rows, or in other suitable configurations. The hybrid plant product template acts as a scaffold from which at least part of the material composition of the shoe or plant product is actually made out of the plant bodies grown from each of the respective cavities. A chia toy may serve as a useful analogy, wherein the hybrid plant product template may be compared to the base of the chia toy, and the growing green chia leaves may be compared to a hybrid plant product. In contrast to a chia toy, a hybrid plant product grown from a template has improved functionality over common plants as the hybrid plant product has mechanical characteristics similar to current shoes.

A hybrid plant product template may have any convenient shape for growing plants, for example, spherical, bubble, cylindrical, cube, or cuboid. The hybrid plant product template contains the environment and growth medium, including nutrients and support, necessary for growth or manufacture of the hybrid plant product. In one embodiment, the hybrid plant product template can be in the form of a shoe to grow plants in that specific shape.

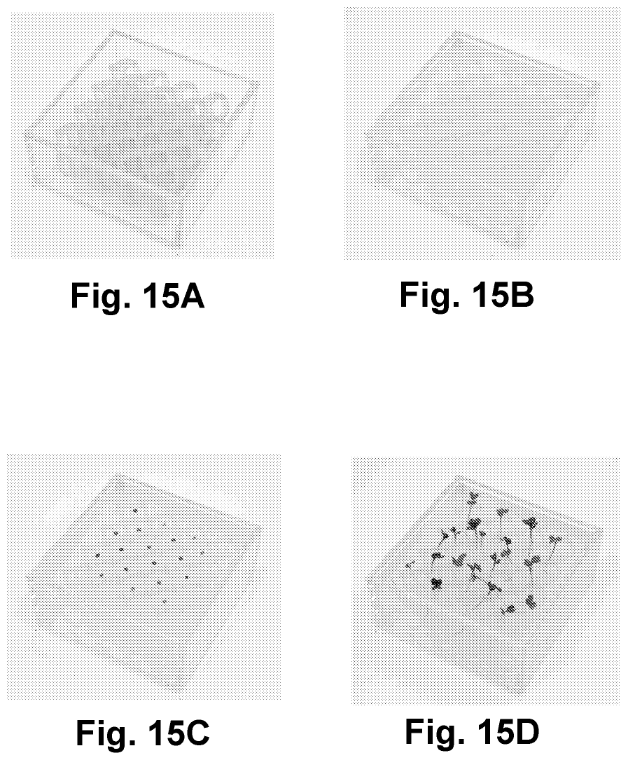

FIGS. 15A-15D illustrate a sequence of growth of plants in an embodiment of a hybrid plant product template. The configuration of the hybrid plant product template and printed substrate in FIGS. 15A-15D is the same as the hybrid plant template shown in FIG. 14B. In accordance with an aspect of the invention, the printed substrate may be prepared using intelligent fibers as discussed above. FIG. 15A shows the 3D printed substrate in a growth module ready for acceptance of a growth medium and embedded seeds. FIG. 15B shows the cell of FIG. 15A further containing a growth medium to support growth of plants. For ease of discussion, the growth medium may be referred to as soil in certain embodiments, but it is to be understood that plants or hybrid plant products may be grown in other environment such as hydroponically. In such cases, the hybrid plant product template may not contain soil and instead contain an alternative plant support material. In exemplary embodiments, the growth medium may be natural, such as soil, bark, or sand; a hydroponic growth medium such as rockwool, perlite, or clay aggregate; or a synthetic growth medium such as agar, Murashige and Skoog medium, or Hoagland solution. In FIG. 15C, plant seeds have been embedded in the growth medium, and these seeds have sprouted and show growth as illustrated in FIG. 15D.

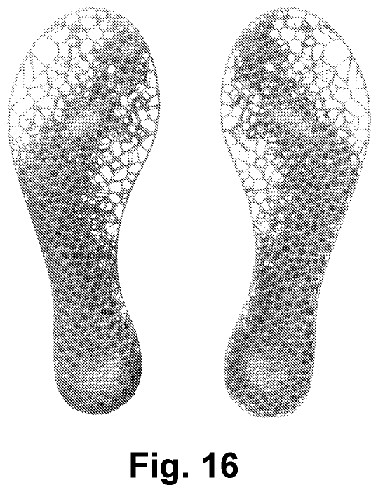

FIG. 16 shows an embodiment of a shoe sole having soil sensitive shoe mechanics for spatial and temporal response. That is, the growing plants forming the sole of a shoe can respond to variations in density and textures of the growth medium via passive or quasi-dynamic material changes. For example, depending on the materials of the growth medium, their composition (or blend) at any particular location of the growth medium, and an information gradient (nutrients, water, temperature, etc.) applied to the plants, the plants forming the shoe sole will grow in a particular pattern and the resultant shoe sole will have a customized structure to provide desired properties and characteristics to the sole such as durability and elasticity. In an exemplary embodiment, the soil can be considered as a continuum of clay, sand, and silt, and designers can predict the entire phase space (the gradient of all possible states and composition possibilities of the soil system). By precisely designing material properties and tuning the soil system and plants (potentially via genetic engineering), shoes, shoe soles, garments, and other structures can be grown using a hybrid plant product template.

The hybrid plant product is prepared during the plant growth stage. For example, to manufacture a shoe out of cotton, a cotton plant can be manipulated through genetic engineering to “instruct” the plant seeds (or other propagative tissue) to grow and weave the fibers in a particular pattern. The cotton seeds (or other tissue) are placed in the scaffold, and the genetic code in the cotton plant causes the cotton fibers to grow in the scaffold and weave a product having a desired shape which can then be assembled into a functioning shoe. The plant maintained in a shoe or garment can be maintained in a suspended growth state by placing it in hydrogels and by modulating growth parameters (such as but not limited to light, nutrients, and temperature).

### Example 1—Hybrid Plant Product Template

A hybrid plant product template was prepared to show the feasibility of the process. A hybrid plant product template having a cuboid shape was prepared, and it contained a printed substrate prepared by 3D-printing using agar or nanocellulose, a biocompatible polymer. The printed substrate had the structure shown in FIG. 14B. The hybrid plant product template containing the printed substrate was charged with micronutrient-rich hydrogel as the growth medium and seeds of genetically engineered Gossypium Hirsutum or Marchantia polymorpha spores were planted in alternating cavities of the substrate. The growth media had a variable content of key macronutrients such as nitrogen (N), phosphorus (P), potassium (K), calcium (Ca), sulfur (S), magnesium (Mg), carbon (C), oxygen (O), hydrogen (H), as well as a modifiable water content and suitable mechanical properties such as porosity, stiffness, and optical transparency. The growth medium was kept moist and warm, and after 1 to 30 days, the seeds sprouted and the plants were allowed to grow for 1 to 730 days, or until reaching a desirable growth profile endpoint.

It will be appreciated by persons having ordinary skill in the art that many variations, additions, modifications, and other applications may be made to what has been particularly shown and described herein by way of embodiments, without departing from the spirit or scope of the invention. Therefore, it is intended that the scope of the invention, as defined by the claims below, includes all foreseeable variations, additions, modifications or applications.

Finally, the above discussion is intended to be merely illustrative of the present invention and should not be construed as limiting the appended claims to any particular embodiment or group of embodiments. Thus, while the present invention has been described with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. Intelligent fibers for forming a product, the intelligent fibers comprising at least one of:
mono-material fiber;
a coaxial fiber; and
a continuous fiber,
wherein the mono-material fiber includes at least two adjacent fibers, a first fiber of the at least two fibers being formed from a first material and being adjacent to a second fiber of the at least two fibers, the second fiber being formed from a second material being different from the first material,
wherein the coaxial fiber includes at least two coaxial fibers, a first fiber of the at least two coaxial fibers being formed from the first material and surrounding a second coaxial fiber of the at least two coaxial fibers formed from the second material, and
wherein the continuous fiber includes at least two serial fibers, a first fiber of the at least two serial fibers being formed from the first material and having a first end connected to a second end of a second serial fiber of the at least two serial fibers formed from the second material.

2. The intelligent fibers of claim 1, wherein the first material includes an optical fiber configured to provide light of at least two colors in response to a detected stimulus, and the second material protects the optical fiber.

3. The intelligent fibers of claim 1, wherein the mono-material fiber, the coaxial fiber; and the continuous fiber include a third fiber of a third material different from the first material and the second material.

4. The intelligent fibers of claim 1, further comprising a plurality of mono-material fibers triaxially interwoven to form the product.

5. The intelligent fibers of claim 1, further comprising a plurality of coaxial fibers three-dimensional (3D) printed to form the product.

6. The intelligent fibers of claim 1, further comprising a plurality of continuous fibers electro-spun to form the product.

7. The intelligent fibers of claim 1, wherein the fibers react to an environmental stimulus to provide a feedback to a user.

8. The intelligent fibers of claim 1, wherein the environmental stimulus is a mechanical, thermal, chemical, biological, or magnetic stimulus.

9. The intelligent fibers of claim 1, wherein the feedback is a change in color, shape, or material property.

10. The intelligent fibers of claim 1, wherein the product is a shoe, garment, textile, building material, or engineered hybrid plant product.

11. The intelligent fibers of claim 1, wherein the fibers comprise one or more materials selected from the group consisting of chromophores, force detection wires, and fiber optics.

12. A method for making a product from intelligent fibers, the method comprising
triaxially interweaving at least three mono-material fiber to form a woven product;
wherein the mono-material fiber includes at least three adjacent fibers, a first fiber of the at least three fibers being formed from a first material and being adjacent to a second fiber of the at least three fibers, the second fiber being formed from a second material being different from the first material, and a third fiber of the at least three fibers being formed from a third material different from the first material and the second material.

13. The method according to claim 12, wherein the product is a textile.

14. A method for making a product from intelligent fibers, the method comprising
three-dimensional (3D) printing at least two coaxial fibers, wherein a first fiber is formed from a first material and surrounds a second coaxial fiber formed from a second material; and
weaving the coaxial fibers on a loom to form the product.

15. The method according to claim 14, wherein the product is a textile.

16. The method of claim 14, wherein the step of three-dimensional printing comprises coaxially printing at least three coaxial fibers, wherein the third coaxial fiber surrounds the second coaxial fiber and is formed from a third material.

17. The method according to claim 14, wherein the product is a textile.

18. A method for making a product from intelligent fibers, the method comprising:
electro-spinning a continuous fiber, wherein the continuous fiber includes at least two serial fibers, a first fiber formed from a first material and having a first end connected to a second end of a second serial fiber formed from the second material, wherein the first and second serial fibers have a different composition; and
weaving the continuous fiber on a loom to form the product.

19. The method of claim 18, wherein the continuous fiber includes at least three serial fibers, wherein the third serial fiber is connected to an end of the second serial fiber.

20. The method according to claim 18, wherein the product is a textile.
